(19) United States
(12) Patent Application Publication
(10) Pub. No.: US 2023/0008624 A1
(43) Pub. Date: Jan. 12, 2023

(54) ROAD SIDE UNIT MESSAGE SCHEDULING AND CONGESTION CONTROL

(71) Applicant: QUALCOMM Incorporated, San Diego, CA (US)

(72) Inventors: Shuping CHEN, Beijing (CN); Yan LI, Beijing (CN); Yue YIN, Beijing (CN)

(21) Appl. No.: 17/757,072

(22) PCT Filed: Jan. 10, 2020
(86) PCT No.: PCT/CN2020/071321

§ 371 Date: Jun. 8, 2022

(51) Int. Cl. H04W 28/02; H04W 24/08

(52) U.S. Cl. CPC H04W 28/0289; H04W 24/08

(57) ABSTRACT

Methods, computing platforms, storage media, and systems for providing congestion control in Road Side Unit message (“RSU message”) scheduling. One aspect of the present disclosure relates to a method for providing congestion control in RSU message scheduling. Various aspects include measuring a channel busy ratio by a PC5 access layer of a Road Side Unit, comparing the measured channel busy ratio to one or more thresholds, and generating and transmitting RSU messages at a rate determined based upon whether the measured channel busy ratio equals or exceeds the one or more thresholds.

### RELATED APPLICATIONS

This application is a national phase application of and claims priority to PCT Application PCT/CN2020/071321 entitle “ROAD SIDE UNIT MESSAGE SCHEDULING AND CONGESTION CONTROL” filed Jan. 10, 2020, the entire contents of which are incorporated herein by reference for all purposes.

### BACKGROUND

Cellular and wireless communication technologies have seen explosive growth over the past several years and are being used to support communications between a host of different types of communication devices, such as smartphones, vehicle-based communication devices, infrastructure communication devices, network communication devices, etc. This growth has been fueled by better communications hardware, larger networks, and more reliable protocols.

The surface transportation industry has increasingly looked to leverage the growing capabilities of cellular and wireless communication technologies through the adoption of Intelligent Transportation Systems (ITS) technologies to increase intercommunication and Safety for both driver-operated vehicles and autonomous vehicles. The cellular vehicle-to-everything (C-V2X) protocol defined by the 3rd Generation Partnership Project (3GPP) supports ITS technologies and serves as the foundation for vehicles to communicate directly with the communication devices around them.

C-V2X communication technologies hold promise for improving vehicle safety, managing traffic congestion and support autonomous and semi-autonomous vehicles.

### SUMMARY

Various aspects include methods performed by a processor of a Road Side Unit for providing congestion control in Road Side Unit (RSU) message (“RSU message”) scheduling. Various aspects include measuring a channel busy ratio by a PC5 access layer of Road Side Unit, comparing the measured channel busy ratio to one or more thresholds, and generating and transmitting RSU messages at a rate determined based upon whether the measured channel busy ratio equals or exceeds the one or more thresholds.

Some aspects include generating and transmitting RSU messages at a first rate in response to the measured channel busy ratio being less than a first threshold, and generating and transmitting RSU messages at a second rate that is less frequent than the first rate in response to the measured channel busy ratio equaling or exceeding the first threshold.

Some aspects include generating and transmitting different types of RSU messages at type-specific first rates in response to the measured channel busy ratio being less than a first threshold, and generating and transmitting the different types of RSU messages at type-specific second rates that are less frequent than the type-specific first rates in response to the measured channel busy ratio equaling or exceeding the first threshold. In some aspects, the different types of RSU messages may include Signal Phase and Timing (SPAT) Messages, Map Data (MAP) Messages, Road Sign Information (RSI) Messages, and Road Safety Messages (RSMs).

Some aspects may further include determining the rate for generating and transmitting RSU messages based upon whether the measured channel busy ratio equals or exceeds the one or more thresholds using a look up table of rates correlated to types of RSU messages and the one or more thresholds.

Some aspects may further include determining whether one or more event triggers for RSU message generation and transmission have occurred and generating and transmitting RSU messages at the rate determined based upon whether the measured channel busy ratio equals or exceeds the one or more thresholds by generating and transmitting RSU messages at the rate determined based upon whether the measured channel busy ratio equals or exceeds the one or more thresholds in response to determining that one or more event triggers for RSU message generation and transmission have occurred.

Various aspects may include determining whether one or more event triggers for RSU message generation and transmission have occurred at an RSU, preventing RSU message generation and transmission in response to determining that that one or more event triggers for RSU message generation and transmission have not occurred, and generating and transmitting RSU messages in response to determining that one or more event triggers for RSU message generation and transmission have occurred. In some aspects, generating and transmitting RSU messages in response to determining that one or more event triggers for RSU message generation and transmission have occurred may include measuring a channel busy ratio by a PC5 access layer of the RSU, comparing the measured channel busy ratio to one or more thresholds, and generating and transmitting RSU messages at a rate determined based upon whether the measured channel busy ratio equals or exceeds the one or more thresholds.

In some aspects, the one or more event triggers may be based at least in part on an RSU message type. In some aspects, the RSU message type may be an RSM and an event trigger may be a detection of a presence of an object or a participant in a vicinity of the RSU. In some aspects, the RSU message type may be an RSI and an event trigger may be a detection of a vehicle approaching the RSU.

Various aspects include a Road Side Unit including a processor configured with processor-executable instructions to perform operations of the methods summarized above. Various aspects also include a non-transitory processor-readable medium on which is stored processor-executable instructions configured to cause a processor of a Road Side Unit to perform operations of the methods summarized above.

### BRIEF DESCRIPTION OF THE DRAWINGS

The accompanying drawings, which are incorporated herein and constitute part of this specification, illustrate exemplary embodiments of the Claims, and together with the general description given above and the detailed description given below, serve to explain the features of the Claims.

FIG. 1 is a system block diagram conceptually illustrating an example cellular vehicle-to-everything (C-V2X) system.

FIG. 2 is a system block diagram of computing device suitable for use in a Road Side Unit according to various embodiments.

FIG. 3 is a component block diagram illustrating a communication device that may be configured to implement methods for providing congestion control in Road Side Unit message scheduling in accordance with various embodiments.

FIG. 4 is a block diagram illustrating an example of interactions between stack architecture layers in a transmitting communication device and a receiving communication device in accordance with various embodiments.

FIG. 5 is a component block diagram illustrating a system configured for providing congestion control in RSU message scheduling in accordance with various embodiments.

FIGS. 6A, 6B, 6C, 6D, 6E, 6F, and 6G are process flow diagrams illustrating methods for providing congestion control in RSU message scheduling according to various embodiments.

FIG. 7 illustrates an example look up table of RSU message transmission rates correlated to the type of RSU messages and one or more thresholds according to various embodiments.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

C-V2X communication technologies hold promise for improving vehicle safety, managing traffic congestion and support autonomous and semi-autonomous vehicles. However, successful implementation of C-V2X communication technologies requires solutions to the problem of communication congestion that will arise when many vehicles present on a roadway (e.g., during commuter traffic) attempt to send basic safety messages at the same time that Road Side Units are sending RSU messages. Various embodiments provide methods for controlling or limiting communication congestion that can be implemented by each Road Side Unit based on measuring the channel busy ratio at the PC5 access layer, and generating and transmitting RSU messages at a rate determined based upon whether the measured channel busy ratio equals or exceeds the one or more thresholds.

As used herein, the term “Road Side Unit” (or “RSU”) refers to highway computing systems that include a processor configured to perform C-V2X communications as well as operations described herein, and a wireless transceiver configured to broadcast RSU messages, including SPAT messages, MAP messages, RSI messages, and RSMs, to vehicles within a reception radius. Road Side Units may be part of a C-V2X communication network or system.

As used herein, the term “communication device” refers to any one or all of cellular telephones, smartphones, portable computing devices, driver assistance systems, vehicle controllers, vehicle system controllers, vehicle communication system, infotainment systems, vehicle telematics systems or subsystems, vehicle display systems or subsystems, vehicle Data controllers or routers, and similar electronic devices which include a programmable processor and memory and circuitry configured to perform operations as described herein. While the various aspects are particularly useful for in-vehicle communication systems and/or computing devices, the aspects are generally useful in any communication device that includes communication circuitry for communicating with Road Side Units and a processor that executes application programs.

The term “system-on-chip” (SoC) is used herein to refer to a set of interconnected electronic circuits typically, but not exclusively, including one or more processors, a memory, and a communication interface. The SoC may include a variety of different types of processors and processor cores, such as a general purpose processor, a central processing unit (CPU), a digital Signal processor (DSP), a graphics processing unit (GPU), an accelerated processing unit (APU), a sub-system processor, an auxiliary processor, a single-core processor, and a multicore processor. The SoC may further embody other hardware and hardware combinations, such as a field programmable gate array (FPGA), a configuration and status register (CSR), an application-specific integrated circuit (ASIC), other programmable logic device, discrete gate logic, transistor logic, registers, performance monitoring hardware, watchdog hardware, counters, and time references. SoCs may be integrated circuits (ICs) configured such that the components of the IC reside on the same substrate, such as a single piece of semiconductor material (e.g., silicon, etc.).

The term “system in a package” (SIP) is used herein to refer to a single module or package that may contain multiple resources, computational units, cores and/or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SoCs coupled together via high speed communication circuitry and packaged in close proximity, such as on a single motherboard or in a single mobile communication device. The proximity of the SoCs facilitates high speed communications and the sharing of memory and resources.

The term “multicore processor” is used herein to refer to a single IC chip or chip package that contains two or more independent processing cores (e.g., CPU core, IP core, GPU core, etc.) configured to read and execute program instructions. An SoC may include multiple multicore processors, and each processor in an SoC may be referred to as a core. The term “multiprocessor” may be used herein to refer to a system or device that includes two or more processing units configured to read and execute program instructions.

Methods, computing platforms, storage media, and systems for providing congestion control in RSU message scheduling are disclosed. In various embodiments, each Road Side Unit may measure a channel busy ratio by a PC5 access layer of the Road Side Unit; compare the measured channel busy ratio to one or more thresholds; and generate and transmitting RSU messages at a rate determined based upon whether the measured channel busy ratio equals or exceeds the one or more thresholds. The channel busy ratio may be determined as a portion of sub-channels in the resource pool whose S-RSSI measured by the ITS station exceed a (pre-) configured threshold sensed over last 100 milliseconds (ms), a definition that is access layer dependent and specified in ETSI TS 136 214. The measured channel busy ratio (e.g., CBRmeasured) may be the channel busy ratio as measured by the PC5 access layer of the Road Side Unit. The rate for generating and transmitting RSU messages may be determined by a processor of a Road Side Unit using a table look up function based on the measured channel busy ratio or thresholds exceeded by the measured channel busy ratio.

Various embodiments may enable RSU message generation and transmission (e.g., broadcast transmission) based on the measured channel busy ratio. The measured channel busy ration may indicate the RSU message load on the PC5 interface and the likelihood of potential congestions or collisions between RSU messages sent over the PC5 interface. For example, a low measured channel busy ratio may indicate that the potential for congestion or collision in RSU messages is low, and a high measured channel busy ratio may indicate a high RSU message load and thus a high likelihood of potential congestion or collision of RSU messages. A high measured channel busy ratio may indicate a need to reduce the RSU message generation rate.

In various embodiments, the measured channel busy ratio may be compared to one or more thresholds, such as one, two, three, four, or more thresholds. As an example, the one or more thresholds may be one or more ranges of channel busy ratios. In various embodiments, the one or more thresholds may be used as indices or criteria in a look up table that correlates the one or more thresholds with transmission rates at which RSU messages may be generated and transmitted by a Road Side Unit to control congestion on the frequencies used for broadcasting RSU messages. As an example, the look up table may be a table of rates correlated to types of RSU messages and the one or more thresholds. In implementations in which two or more thresholds are present, the message generation and transmission rate correlated with each of the two or more thresholds may be configured such that messages are generated less frequently as the measured channel busy rate thresholds increase. In various embodiments, the message generation and transmission rates may be different for different types of RSU messages correlated with the same threshold. Types of RSU messages may include Signal Phase and Timing (SPAT) messages; Map Data (MAP) messages, Road Sign Information (RSI) messages, and Road Safety Messages (RSMs).

In various embodiments, the Road Side Unit may generate and transmit RSU messages at the rate determined based upon the measured channel busy ratio equaling or exceeding the one or more thresholds. For example, the RSU messages may be generated and transmitted at a rate listed in a look up table corresponding to the rate that was correlated with the threshold range in which the measured channel busy ratio was determined to fall. The reduction of the rate of RSU message generation and transmission as the measured channel busy ration increases may reduce congestion on the PC5 interface with Road Side Units acting independently (i.e., without the need for a centralized congestion control mechanism). The reduction of the rate of RSU message generation and transmission as the measured channel busy ration increases may enable the Road Side Unit to save energy by generating and transmitting less RSU messages when potential congestion on the PC5 interface is more likely.

Various embodiments may include methods for achieving RSU message congestion control by limiting transmission of RSU messages in response to the presence of one or more event triggers that relate to whether there is a need for the RSU message (e.g., whether there is a vehicle present to receive the message). In various embodiments, a Road Side Unit may monitor states of the Road Side Unit and/or the vicinity around the Road Side Unit, such as using sensors (e.g., radars, LIDAR, cameras, etc.) of the Road Side Unit and/or the detection of messages from other entities, such as monitoring BSMs transmitted by vehicles approaching the Road Side Unit. For example, a Road Side Unit may detect the presence of an object (e.g., a vehicle, obstruction in the road, etc.) or a participant (e.g., a pedestrian, a bicycle, an animal, etc.) in a vicinity of the Road Side Unit, which may be an event trigger if that presence provides a reason for transmitting an RSU message or a proper recipient for such a message. As another example, the Road Side Unit may detect a vehicle approaching the Road Side Unit, which may be an event trigger, such as when the Road Side Unit has a message to send to any vehicle in the vicinity. For example, if the Road Side Unit has an RSI message to send regarding a roadway sign, the approach of a vehicle that can receive the RSI message may be an event trigger to broadcast that message. In various embodiments, event triggers may be based at least in part on the RSU message type. For example, event triggers for RSI messages may be different than event triggers for RSMs. As specific examples, the detection of a presence of an object or a participant in a vicinity of the Road Side Unit may be an event trigger for an RSM and the detection of a vehicle approaching the Road Side Unit may be an event trigger for an RSI message.

In various embodiments, the Road Side Unit may prevent the generation and transmission of RSU messages until one or more event triggers is determined to have occurred. In various embodiments, the Road Side Unit may determine whether one or more event triggers for RSU message generation and transmission have occurred at the Road Side Unit. In response to determining that one or more event triggers for RSU message generation and transmission have not occurred, the Road Side Unit may prevent RSU message generation and transmission. In response to determining that one or more event triggers for RSU message generation and transmission have occurred, the Road Side Unit may generate and transmit RSU messages. In various embodiments, the rate at which RSU messages are generated and transmitted in response to detecting one or more event triggers may be based at least in part on the measured channel busy ratio as described herein.

In various embodiments, the prevention of RSU message generation and transmission may be RSU message type specific. For example, RSI message generation and transmission may be prevented until an event trigger associated with the RSI message is determined to have occurred (e.g., a vehicle that can or should receive the RSI message is approaching). Some RSM messages may only generated and transmitted in response detecting an associated event trigger. For example, a roadway obstruction RSM may generated and transmitted by a Road Side Unit in response to determining that that an object or a participant is present in the roadway near Road Side Unit. Limiting RSU message generation and transmission until an event trigger has occurred may reduce the contribution of RSU messages to congestion on the PC5 interface as unneeded messages will not be transmitted. Also, limiting RSU message generation and transmission until an event trigger has occurred may enable the Road Side Unit to save energy by not generating and transmitting RSU messages that are unnecessary.

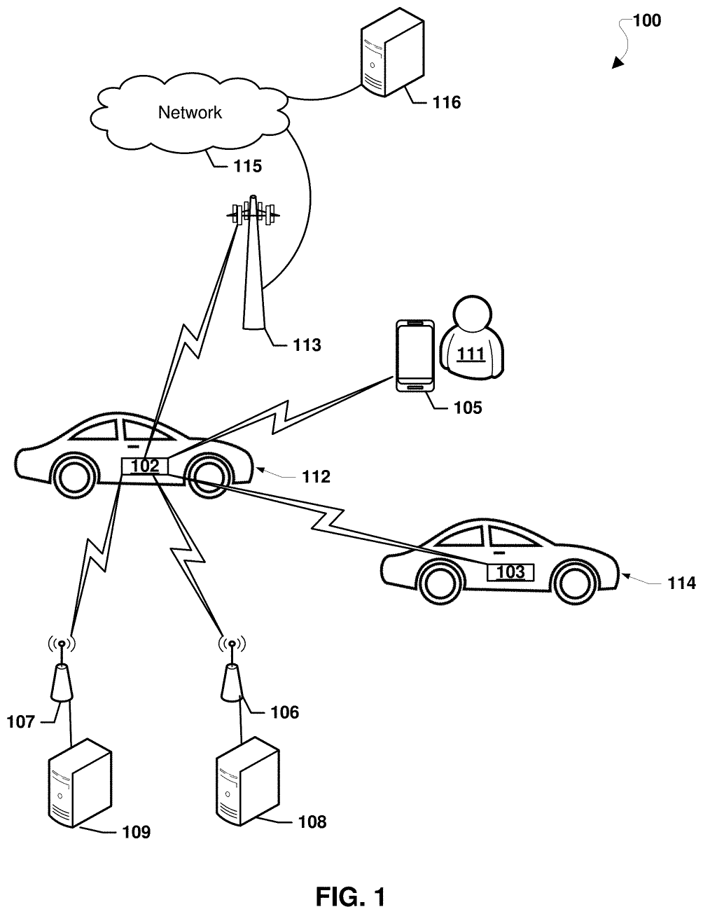

FIG. 1 illustrates an example C-V2X system 100 suitable for implementing various embodiments. A C-V2X system 100 may include an in-vehicle communication device 102 configured to exchange wireless communications with other communication devices around a vehicle 112 in which the in-vehicle communication device 102 is located. The vehicle 112 may be any type of vehicle, such as an autonomous vehicle (e.g., driverless car, etc.), semi-autonomous vehicle, remotely operated vehicle, etc. The in-vehicle communication device 102 may be a computing device mounted in the vehicle 112 or may be a mobile communication device (e.g., a smartphone, laptop, etc.) temporarily placed within the vehicle 112. The C-V2X system 100 may include various devices in addition to the in-vehicle communication device 102, such as another in-vehicle communication device 103 of another vehicle 114, transmitters 106 and 107 connected to Road Side Units 108, 109, communication device 105 (e.g., a smartphone, laptop, etc.), cellular tower or base station 113 connected to a network 115 and network server 116, etc. Various components of the C-V2X system 100 may be configured to operate as an ITS network to support intercommunication and Safety for surface vehicles.

The in-vehicle communication device 102 may be configured to perform vehicle-to-vehicle (V2V) communications, vehicle-to-infrastructure (V2I) communications, and vehicle-to-pedestrian (V2P) communications. For example, the in-vehicle communication device 102 may establish a device-to-device (D2D) link with another in-vehicle communication device 103 of another vehicle 114 to exchange V2V communications. As another example, the in-vehicle communication device 102 may establish D2D links with transmitters 106 and 107 connected to Road Side Units 108, 109 to exchange V2I communications. As a further example, the in-vehicle communication device 102 may establish a D2D link with the communication device 105, such as a smartphone, laptop, etc., of a user 111 to exchange V2P communications. The D2D links between the in-vehicle communication device 102, the in-vehicle communication device 103, the communication device 105, the Road Side Units 108, 109 may be communication links established independent of a cellular network, such as links establish in the dedicated ITS 5.9 gigahertz (GHz) spectrum. As specific examples, the D2D links may be dedicated short range communication (DSRC) links, LTE direct (LTE-D) links, or any other type link supporting direct device communication.

The in-vehicle communication device 102 may be configured to perform vehicle-to-network (V2N) communications. For example, the in-vehicle communication device 102 may establish network-to-device links with a cellular tower or base station 113 connected to a network 115 and a network server 116 to exchange V2N communications. The network-to-device links may include, without limitation, uplinks (or reverse links), downlinks (or forward links), bidirectional links, etc. The network-to-device links may be established according to mobile broadband systems and technologies, such as third generation wireless mobile communication technologies (3G) (e.g., global system for mobile communications (GSM) evolution (EDGE) systems, code division multiple access (CDMA) 2000 systems, etc.), fourth generation wireless mobile communication technologies (4G) (e.g., long term evolution (LTE) systems, LTE-Advanced systems, mobile Worldwide Interoperability for Microwave Access (mobile WiMAX) systems, etc.), fifth generation wireless mobile communication technologies (5G) (e.g., 5G New Radio (5G NR) systems, etc.), etc.

In some embodiments, the in-vehicle communication device 102 and the cellular tower or base station 113 may include 5G NR functionality with an air interface based on orthogonal frequency division multiplexing (OFDM). The functionality of the cellular tower or base station 113 may be similar in one or more aspects to (or incorporated into) the functionality of a cellular IoT (CIoT) base station (C-BS), a NodeB, an evolved NodeB (eNodeB), radio access network (RAN) access node, a radio network controller (RNC), a base station (BS), a macro cell, a macro node, a Home eNB (HeNB), a femto cell, a femto node, a pico node, or some other suitable entity based on the radio technology used to establish the network-to-device links between the cellular tower or base station 113 and the in-vehicle communication device 102. The cellular tower or base station 113 may be in communication with respective routers that may connect to the network 115 (e.g., core network, Internet, etc.). Using the connections to the cellular tower or base station 113, the in-vehicle communication device 102 may exchange Data with the network 115 as well as devices connected to the network 115, such as a network server 116 or any other communication device connected to the network 115.

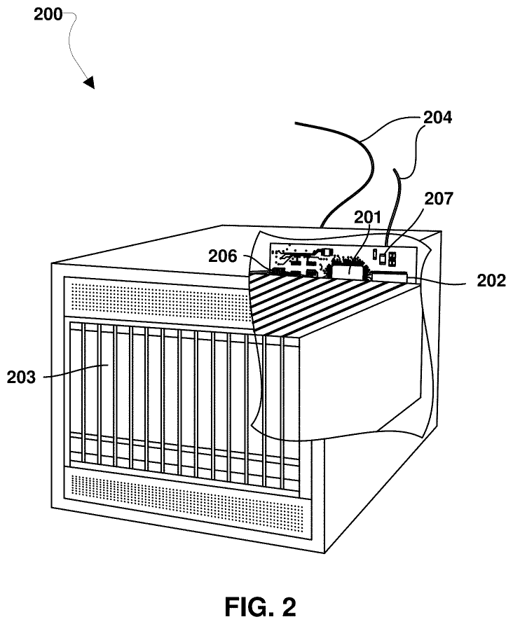

FIG. 2 is a component block diagram of an example Road Side Unit 200, such as a base station, smart street sign, etc., suitable for use in various implementations. Such Road Side Units may include at least the components illustrated in FIG. 2. With reference to FIGS. 1-2, the Road Side Unit 200 may typically include a processor 201 coupled to volatile memory 202 and a large capacity nonvolatile memory, such as a disk drive 203. The Road Side Unit 200 may include one or more antennas 207 for sending and receiving wireless RSU messages (e.g., Signal Phase and Timing (SPAT) messages; Map Data (MAP) messages, Road Sign Information (RSI) messages, and Road Safety Messages (RSM)). The Road Side Unit 200 also may include a peripheral memory access device such as a floppy disc drive, compact disc (CD) or digital video disc (DVD) drive 206 coupled to the processor 201. The Road Side Unit 200 also may include network access ports 204 (or interfaces) coupled to the processor 201 for establishing data connections with a network, such as the Internet or a local area network coupled to other system computers and servers. The Road Side Unit 200 may include additional access ports, such as USB, Firewire, Thunderbolt, and the like for coupling to peripherals, external memory, or other devices.

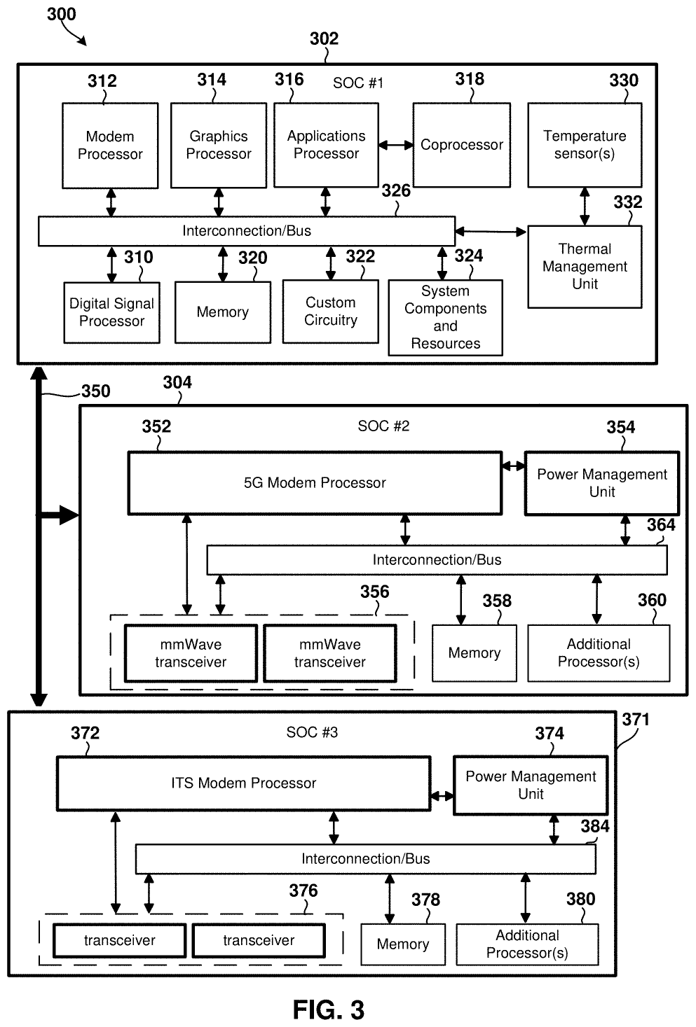

The various embodiments may be implemented on a number of single processor and multiprocessor communication devices, including an SoC and/or an SIP. FIG. 3 illustrates an example SIP 300 architecture that may be configured to implement methods for providing congestion control in Road Side Unit message scheduling in accordance with various embodiments. With reference to FIGS. 1-3, example SIP 300 architecture may be implemented in any SIP, and may be used in any communication device (e.g., in-vehicle communication device 102, in-vehicle communication device 103 Road Side Unit 108, 109, 200, etc.) implementing various embodiments.

In the example illustrated in FIG. 3, the SIP 300 includes three SoCs 302, 304, 371. In some embodiments, the first SoC 302 may operate as a central processing unit (CPU) of the communication device that carries out the instructions of software application programs by performing the arithmetic, logical, control and input/output (I/O) operations specified by the instructions. In some embodiments, the second SoC 304 may operate as a specialized processing unit. For example, the second SoC 304 may operate as a specialized 5G processing unit responsible for managing high volume, high speed (e.g., 5 Gbps, etc.), and/or very high frequency short wave length (e.g., 28 GHz mmWave spectrum, etc.) communications to support 5G NR functionality with an air interface based on OFDM. In some embodiments, the third SoC 371 may operate as a specialized processing unit. For example, the third SoC 371 may operate as a specialized C-V2X processing unit responsible for managing V2V, V2I, and V2P communications over D2D links, such as D2D links establish in the dedicated ITS 5.9 GHz spectrum communications. The SoCs and organization of functionality illustrated in FIG. 3 are a non-limiting example of a SIP as other architectures and organizations of functionality among SoCs, including fewer or more SoCs, are contemplated.

In the example illustrated in FIG. 3, the first SoC 302 includes a digital Signal processor (DSP) 310, a modem processor 312, a graphics processor 314, an application processor 316, one or more coprocessors 318 (e.g., vector co-processor) connected to one or more of the processors, memory 320, custom circuitry 322, system components and resources 324, an interconnection/bus module 326, one or more temperature sensors 330, and a thermal management unit 332. The second SoC 304 includes a 5G modem processor 352, a power management unit 354, an interconnection/bus module 364, a plurality of mmWave transceivers 356, memory 358, and various additional processors 360, such as an applications processor, packet processor, etc. The third SoC 371 includes an ITS modem processor 372, a power management unit 374, an interconnection/bus module 384, a plurality of transceivers 376 (e.g., transceivers configured to operate in the dedicated ITS 5.9 GHz spectrum), memory 378, and various additional processors 380, such as an applications processor, packet processor, etc.

Each processor 310, 312, 314, 316, 318, 352, 360, 372, 380 may include one or more cores, and each processor/core may perform operations independent of the other processors/cores. For example, the first SoC 302 may include a processor that executes a first type of operating system (e.g., FreeBSD, LINUX, OS X, etc.) and a processor that executes a second type of operating system (e.g., MICROSOFT WINDOWS 10). In addition, any or all of the processors 310, 312, 314, 316, 318, 352, 360, 372, 380 may be included as part of a processor cluster architecture (e.g., a synchronous processor cluster architecture, an asynchronous or heterogeneous processor cluster architecture, etc.).

The first, second, and third SoCs 302, 304, 371 may include various system components, resources and custom circuitry for managing sensor Data, analog-to-digital conversions, wireless Data transmissions, and for performing other specialized operations, such as decoding Data packets and processing encoded audio and video signals for rendering in a web browser or other display application. For example, the system components and resources 324 of the first SoC 302 may include power amplifiers, voltage regulators, oscillators, phase-locked loops, peripheral bridges, Data controllers, memory controllers, system controllers, access ports, timers, and other similar components used to support the processors and software clients running on a wireless device. The system components and resources 324 and/or custom circuitry 322 may also include circuitry to interface with peripheral devices, such as cameras, electronic displays, wireless communication devices, external memory chips, autonomous driving systems, traffic sign recognition systems, parking assistance systems, telematics units, tire pressure monitoring systems, collision warning systems, display systems, ADASs, vehicle buses, etc.

The first, second, and third SoCs 302, 304, 371 may communicate via one or more interconnection/bus modules 350. The processors 310, 312, 314, 316, 318 may be interconnected to one or more memory elements 320, system components and resources 324, and custom circuitry 322, and a thermal management unit 332 via an interconnection/bus module 326. Similarly, the processors 352, 360 may be interconnected to the power management unit 354, the mmWave transceivers 356, memory 358, and various additional processors 360 via the interconnection/bus module 364. Similarly, the processors 372, 380 may be interconnected to the power management unit 374, the transceivers 376, memory 378, and various additional processors 380 via the interconnection/bus module 384. The interconnection/bus module 326, 350, 364, 384 may include an array of reconfigurable logic gates and/or implement a bus architecture (e.g., CoreConnect, AMBA, etc.). Communications may be provided by advanced interconnects, such as high-performance networks-on chip (NoCs).

The first, second, and/or third SoCs 302, 304, 371 may further include an input/output module (not illustrated) for communicating with resources external to the SoCs. Resources external to the SoCs may be shared by two or more of the internal SoC processors/cores.

In addition to the SIP 300 discussed above, the various aspects may be implemented in a wide variety of communication devices, which may include a single processor, multiple processors, multicore processors, or any combination thereof.

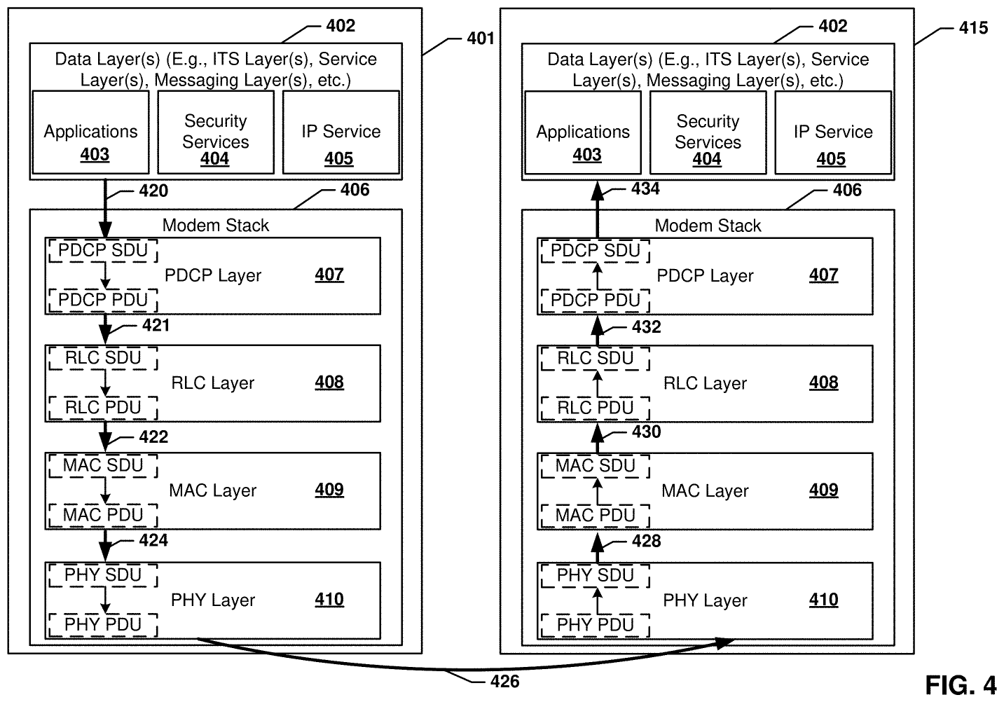

FIG. 4 illustrates interactions between stack architecture layers in a transmitting Road Side Unit 401 and a receiving vehicle onboard unit 415 in a PC5 interface between the Road Side Units and vehicle onboard units used for V2X sidelink communication in accordance with various embodiments. With reference to FIGS. 1-4, the Road Side Unit 401 and vehicle onboard unit 415 may be configured to exchange information using C-V2X communications.

Each Road Side Unit 401 and vehicle onboard unit 415 may include one or more higher data layers 402 configured to exchange data with a modem stack (or radio protocol stack) 406. As examples, the higher data layers 402 may be one or more ITS layers, one or more service layers, one or more messaging layers, application layers, etc. As examples, the functionality performed in the higher data layers 402 may include applications 403 (e.g., ITS Safety critical applications, ITS non-safety critical applications, messaging applications, etc.), security services 404, Internet Protocol (IP) services 405 (e.g., Transmission Control Protocol (TCP) services, Uniform Datagram Protocol (UDP) services, etc.), other higher data layer functionality, or any combination thereof. In some embodiments, the higher data layers 402 and the modem stack 406 on the Road Side Unit 401 and vehicle onboard unit 415 may be running on the same processor of the Road Side Unit 401 and vehicle onboard unit 415. In some embodiments, the higher data layers 402 and the modem stack 406 on the Road Side Unit 401 and vehicle onboard unit 415 may run on different processors of the Road Side Unit 401 and vehicle onboard unit 415. As an example, the higher data layers 402 may run on an application processor (e.g., application processor 316) and the modem stack 406 may run on a modem processor (e.g., modem processor 312, modem processor 352, modem processor 372). While illustrated in FIG. 4 as being on the same Road Side Unit 401 and vehicle onboard unit 415, in some embodiments, the higher data layers 402 may run on a processor of a separate communication device. For example, the higher data layers 402 may run on a processor of an ADAS and the modem stack 406 may run on a processor of a SIP (e.g., SIP 300) connected to the processor of the ADAS.

In some embodiments, the modem stack 406 may include a packet data convergence protocol (PDCP) layer 407, an RLC layer 408, a media access control (MAC) layer 409, and a physical (PHY) layer 410. The PHY 410 may be the lowest layer of the modem stack 406 and the PDCP layer 407 may be the highest layer of the modem stack 406.

The PDCP layer 407 may handle PDCP packets and may provide multiplexing between different radio bearers and logical channels, compression, ciphering, and/or integrity protection for the PDCP packets. The PDCP layer 407 may receive packets from the higher data layers 402 and may output packets to the higher data layers 402. The PDCP layer 407 may receive packets from the RLC layer 408 and may output packets to the RLC layer 408.

The RLC layer 408 may handle RLC packets and may provide error correction, concatenation, segmentation, reassembly, reordering, duplication detection, error detection, and/or error recovery for the RLC packets. Additionally, the RLC layer 408 may buffer RLC packets in a reception buffer, such as to support reordering, await missing RLC packets, etc. The RLC layer 408 may operate in different modes, such as an acknowledge mode (AM), unacknowledged mode (UM), and transparent mode (TM). The RLC layer 408 may receive packets from the PDCP layer 407 and may output packets to the PDCP layer 407. The RLC layer 408 may receive packets from the MAC layer 409 and may output packets to the MAC layer 409.

The MAC layer 409 may handle MAC packets and may provide frame delimiting/recognition, addressing, and/or error protection for the MAC packets. Additionally, the MAC layer may be responsible for hybrid automatic repeat request (HARD) operations. The MAC layer 409 may receive packets from the RLC layer 408 and may output packets to the RLC layer 408. The MAC layer 409 may receive packets from the PHY layer 410 and may output packets to the PHY layer 410.

The PHY layer 410 may handle PHY packets and may provide the communication interface between the hardware supporting the physical transmission medium (e.g., transceivers, antennas, etc.) and the higher layers of the modem stack 406. The PHY layer 410 may convert PHY packets into a bitstream for transmission and/or convert a received bitstream into PHY packets. The PHY layer 410 provide encoding, transmission, reception, and/or decoding for the PHY packets. The PHY layer 410 may receive packets from the MAC layer 409 and may output packets to the MAC layer 409.

The packets transferred to/from a higher data layer of the modem stack 406 may be referred to as service data units (SDUs) in a given layer and packets transferred to/from a lower layer of the modem stack 406 may be referred to as protocol data units (PDUs). For example, the packets received into the RLC layer 408 from the PDCP layer 407, as well as the packets transferred from the RLC layer 408 to the PDCP layer 407, may be referred to as RLC SDUs. Similarly, the packets received into the RLC layer 408 from the MAC layer 409, as well as the packets transferred from the RLC layer 408 to the MAC layer 409, may be referred to as RLC PDUs.

A layer's SDU may be the next higher layer's PDU, just as the layer's PDU may be the next lower layer's SDU. For example, a PDCP PDU sent to the RLC layer 408 from the PDCP layer 407 may be referred to as an RLC SDU upon receipt by the RLC layer 408. Similarly, a MAC SDU sent from the MAC layer 409 to the RLC layer 408 may be referred to as an RLC PDU upon receipt by the RLC layer 408.

Layers within the protocol stack may convert PDUs to SDUs and SDUs to PDUs by performing on the packets various operations assigned to that layer. For example, an RLC SDU may be segmented by the RLC layer 408 to cover the RLC SDU into one or more RLC PDUs. Similarly, a plurality of received RLC PDUs may be reordered and reassembled to covert the plurality of received RLC PDUs to an RLC SDU. Additionally, a layer may add data to a packet to covert an SDU to a PDU or a layer may remove data from a packet to convert a PDU to an SDU. For example, an RLC layer 408 may add a packet header/footer to an RLC SDU to convert the RLC SDU to an RLC PDU. Similarly, an RLC layer 408 may remove a packet header/footer from an RLC PDU to covert the RLC PDU to an RLC SDU.

Referring to FIG. 4, the following is an example of packet handling when one communication device 401 transmits a communication that is received by another communication device 415.

An application of the higher data layer 402 of the transmitting communication device 401 may generate a packet of a message 420 for transmission to an application 403 of the receiving communication device. The packet of the message 420 may be sent from the higher data later 401 to the PDCP layer 407 of the modem stack 406 on the transmitting communication device 401.

The PDCP layer 407 may receive the packet of the message 420 as a PDCP SDU and convert the PDCP SDU to a PDCP PDU 421. The PDCP layer 407 may transfer the PDCP PDU 421 to the lower RLC layer 408.

The RLC layer 408 may receive the PDCP PDU 421 as an RLC SDU, and may convert the RLC SDU (i.e., the PDCP PDU 421) to one or more RLC PDUs 422 by, for example, adding an RLC packet header/footer and/or applying segmentation. As an example, segmentation to split the RLC SDU into multiple RLC PDUs 422 may be needed when the RLC SDU (i.e., the PDCP PDU 421) is larger than a maximum RLC PDU size. When segmentation is applied to convert the RLC SDU into multiple RLC PDUs 422, each created RLC PDU 422 may be associated with a single RLC SDU (i.e., a single PDCP PDU 421). Additionally, the RLC layer 408 may add sequence numbers to the one or more RLC PDUs 422. The sequence numbers may indicate an ordering of the one or more RLC PDUs 422. The RLC layer 408 may transfer the one or more RLC PDUs 422 to the lower MAC layer 409.

The MAC layer 409 may receive the one or more RLC PDUs 422 as one or more MAC SDUs. The MAC layer 409 may convert the one or more MAC SDUs (i.e., the one or more RLC PDUs 422) to one or more MAC PDUs 424. For example, the MAC layer 409 may convert the one or more MAC SDUs (i.e., the one or more RLC PDUs 422) by adding HARQ indicators to the MAC SDU (i.e., the one or more RLC PDUs 422) to support HARQ operations. The MAC layer 409 may transfer the one or more MAC PDUs 424 to the lower PHY layer 410

The PHY layer 410 may receive the one or more MAC PDUs as one or more PHY SDUs. The PHY layer 410 may convert the one or more PHY SDUs (i.e., the one or more MAC PDUs 424) to a PHY PDU bitstream for transmission as a flow 426 to the receiving communication device 415.

The PHY layer 410 of the receiving communication device 415 may receive the PHY PDU bitstream flow 426 and convert the PHY PDU bitstream flow 426 to one or more PHY SDUs 428. The PHY layer 408 may transfer the one or more PHY SDUs 428 to the higher MAC layer 409

The MAC layer 409 may receive the one or more PHY SDUs 428 as one or more MAC PDUs. The MAC layer 409 may convert the one or more MAC PDUs (i.e., one or more PHY SDUs 428) to one or more MAC SDUs 430. Additionally, the MAC layer 409 may perform HARQ operations (e.g., acknowledgements, retransmission requests, etc.) and remove HARQ Data from the MAC PDUs. The MAC layer 409 may transfer the one or more MAC SDUs 430 to the higher RLC layer 408.

The RLC layer 408 may receive the one or more MAC SDUs 430 as one or more RLC PDUs. The RLC layer 408 may convert the one or more RLC PDUs (i.e., the one or more MAC SDUs 430) to a single RLC SDU 432. For example, converting the one or more RLC PDUs (i.e., the one or more MAC SDUs 430) to a single RLC SDU 432 may include removing any RLC headers, removing any RLC footers, combining/concatenating multiple RLC PDUs associated with the same RLC SDU together, and reordering RLC PDUs as needed. Additionally, the RLC layer 408 may buffer one or more RLC PDUs in a reception buffer, such as to support reordering, await missing RLC PDUs, etc. The RLC layer 408 may transfer the RLC SDU 432 to the higher PDCP layer 407.

The PDCP layer 407 may receive the RLC SDU 432 as a PDCP PDU, and convert the PDCP PDU (i.e., the RLC SDU 432) to a PDCP SDU 434. The PDCP SDU 434 at the receiving communication device 415 may correspond to the packet of a message 420 originated by the transmitting communication device 401. The PDCP layer 407 may transfer the PDCP SDU 434 to the higher Data layer 402 and the application 403.

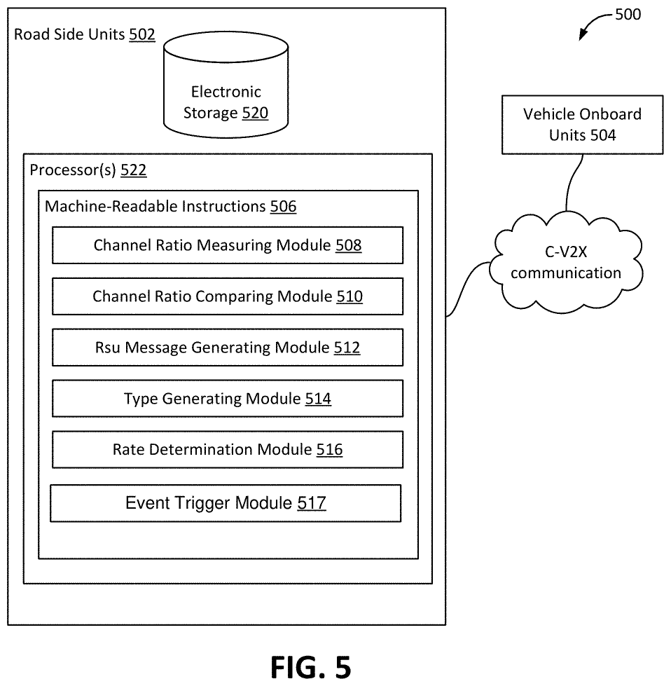

FIG. 5 is a component block diagram illustrating a system 500 configured for providing congestion control in Road Side Unit message (RSU message) scheduling in accordance with various embodiments. In some embodiments, system 500 may include one or more Road Side Units 502 and/or one or more vehicle onboard units 504. With reference to FIGS. 1-5, Road Side Unit(s) 502 may include a communication device (e.g., in-vehicle communication device 102, in-vehicle communication device 103, SIP 300, communication devices 401, 415, communication device 105, etc.), transmitters 106, 107, Road Side Units 108, 109, cellular tower or base station 113, and/or network server 116. Remote platform(s) 504 may include communication device (e.g., in-vehicle communication device 102, in-vehicle communication device 103, SIP 300, communication devices 401, 415, communication device 105, etc.), transmitters 106, 107, Road Side Units 108, 109, cellular tower or base station 113, and/or network server 116).

Road side units(s) 502 may be configured by machine-readable instructions 506. Machine-readable instructions 506 may include one or more instruction modules. The instruction modules may include computer program modules. The instruction modules may include one or more of channel ratio measuring module 508, channel ratio comparing module 510, RSU message generating module 512, type generating module 514, rate determination module 516, and/or other instruction modules.

Channel ratio measuring module 508 may be configured to measure a channel busy ratio by a PC5 access layer of a Road Side Unit. The channel busy ratio may be determined as a portion of sub-channels in the resource pool whose S-RSSI measured by the ITS station exceed a (pre-)configured threshold sensed over a last 100 milliseconds (ms), a definition that is access layer dependent and specified in ETSI TS 136 214. The measured channel busy ratio (e.g., CBRmeasured) may be the channel busy ratio as measured by the PC5 access layer of the Road Side Unit.

Channel ratio comparing module 510 may be configured to compare the measured channel busy ratio to one or more thresholds. In various embodiments, the measured channel busy ratio may be compared to one or more thresholds, such as one, two, three, four, or more thresholds. In various embodiments, the one or more thresholds may be reflected in a look up table that correlates the one or more thresholds with transmission rates for various types of RSU messages.

RSU message generating module 512 may be configured to generate and transmitting RSU messages at a rate determined based upon whether the measured channel busy ratio equals or exceeds the one or more thresholds. In various embodiments, the Road Side Unit may generate and transmit RSU messages at the rate determined based upon the measured channel busy ratio equaling or exceeding the one or more thresholds. For example, the RSU messages may be generated and transmitted at a rate listed in a look up table corresponding to the rate that was correlated with the threshold range in which the measured channel busy ratio was determined to fall. RSU message generating module 512 may be configured to generate and transmitting RSU messages at a first rate in response to the measured channel busy ratio being less than a first threshold. RSU message generating module 512 may be configured to generate and transmitting RSU messages at a second rate that is less frequent than the first rate in response to the measured channel busy ratio equaling or exceeding the threshold. RSU message generating module 512 may be configured to prevent the generation and transmission of RSU messages until one or more event triggers is determined to have occurred, or generate and transmit RSU messages in response to detecting one or more event triggers. RSU message generating module 512 may be configured to determine whether one or more event triggers for an RSU message have occurred at the Road Side Unit. In response to determining that one or more event triggers for the RSU message has not occurred, the RSU message generating module 512 may transmit the RSU message. In response to determining that one or more event triggers for the RSU message has occurred, the RSU message generating module 512 may generate and transmit the RSU messages. In various embodiments, the rate at which RSU messages are generated and transmitted in response to determining that one or more event triggers for RSU messages has occurred may be based at least in part on the measured channel busy ratio.

Type generating module 514 may be configured to generate and transmitting different types of RSU messages at type-specific first rates in response to the measured channel busy ratio being less than a first threshold. In various embodiments, the message generation and transmission rates may be different for different types of RSU messages correlated with the same threshold. By way of non-limiting example, the different types of RSU messages may include Signal Phase and Timing Messages, Map Data Messages, RSI Messages, and Road Safety Messages. Type generating module 514 may be configured to generate and transmitting the different types of RSU messages at type-specific second rates that are less frequent than the type-specific first rates in response to the measured channel busy ratio equaling or exceeding the threshold.

Rate determination module 516 may be configured to determine the rate for generating and transmitting RSU messages based upon whether the measured channel busy ratio equals or exceeds the one or more thresholds using a look up table of rates correlated to types of RSU messages and the one or more thresholds. The rate for generating and transmitting RSU messages may be determined by a processor of a Road Side Unit using a table look up function based on the measured channel busy ratio or thresholds exceeded by the measured channel busy ratio.

Event trigger module 517 may be configured to determine whether one or more event triggers for RSU messages have occurred. Event trigger module 517 may be configured to monitor states of the Road Side Unit and/or the vicinity around the Road Side Unit. Event trigger module 517 may be configured to monitor states of the Road Side Unit and/or the vicinity around the Road Side Unit using sensors (e.g., radars, LIDAR, cameras, etc.) of the Road Side Unit and/or the detection of messages from other entities (e.g., BSMs from vehicles approaching the Road Side Unit). For example, event trigger module 517 may be configured to detect of a presence of an object (e.g., a vehicle, obstruction, etc.) or a participant (e.g., a pedestrian, a bicycle, an animal, etc.) in the roadway in a vicinity of the Road Side Unit, which may be an event trigger for an RSM. As another example, the Event trigger module 517 may be configured to detect a vehicle approaching the Road Side Unit, which may be an event trigger for an RSU message. In various embodiments, event triggers may be based at least in part on the RSU message type. For example, event triggers for RSI messages may be different than event triggers for RSMs. As specific examples, the detection of a presence of an object or a participant in a vicinity of the Road Side Unit may be an event trigger for an RSM and the detection of a vehicle approaching the Road Side Unit may be an event trigger for an RSI message.

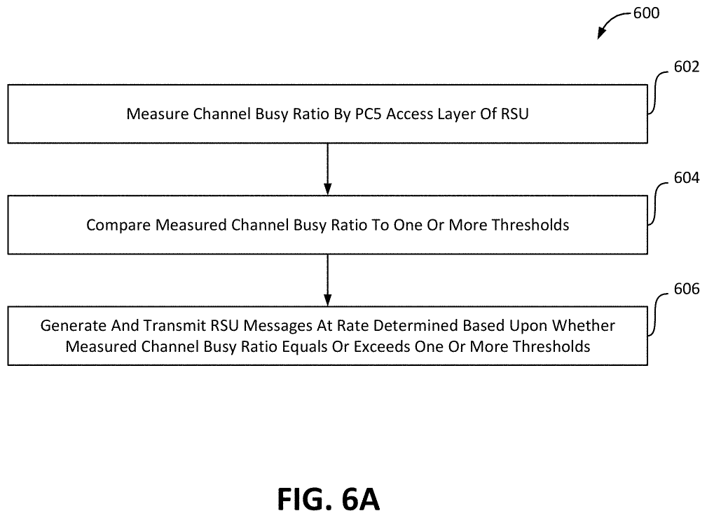

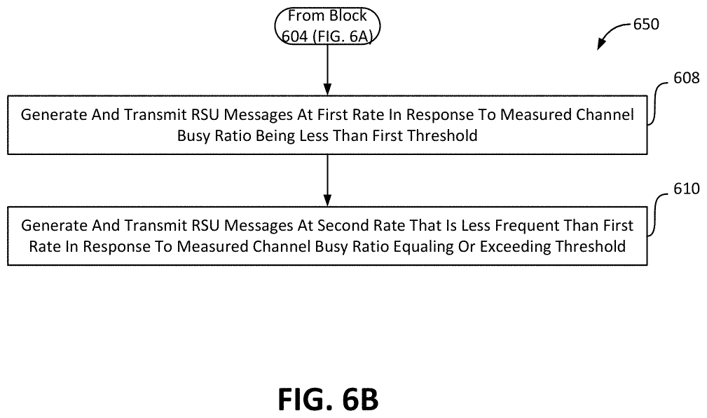

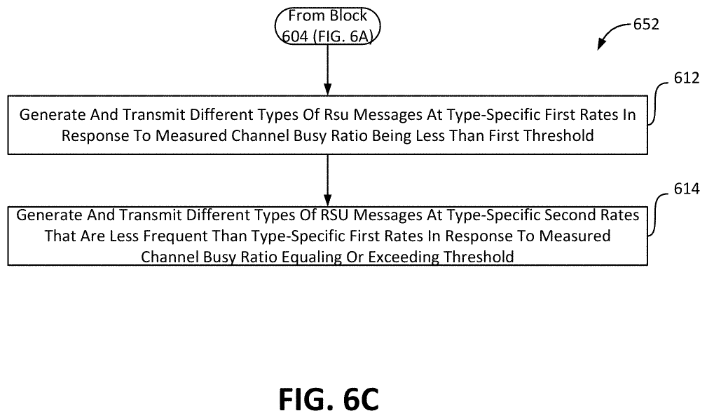

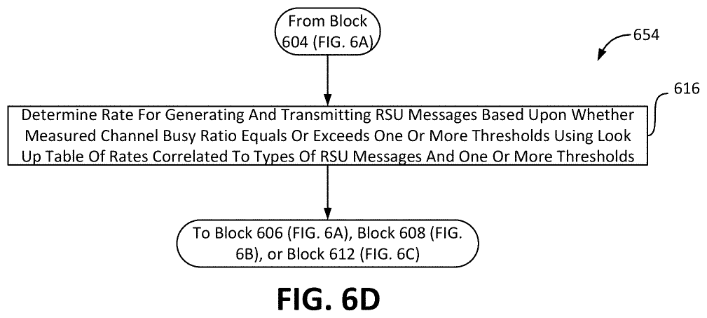

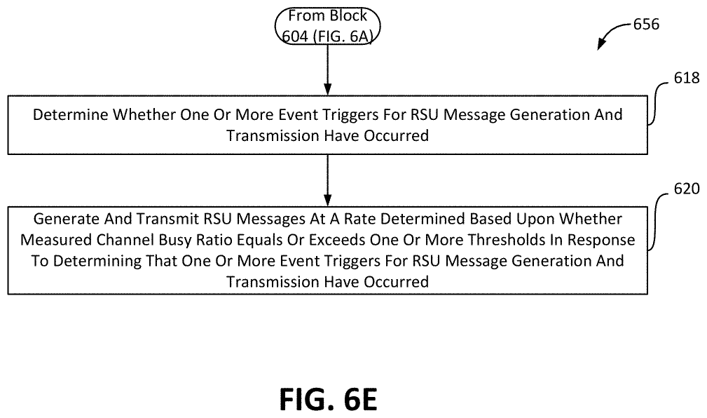

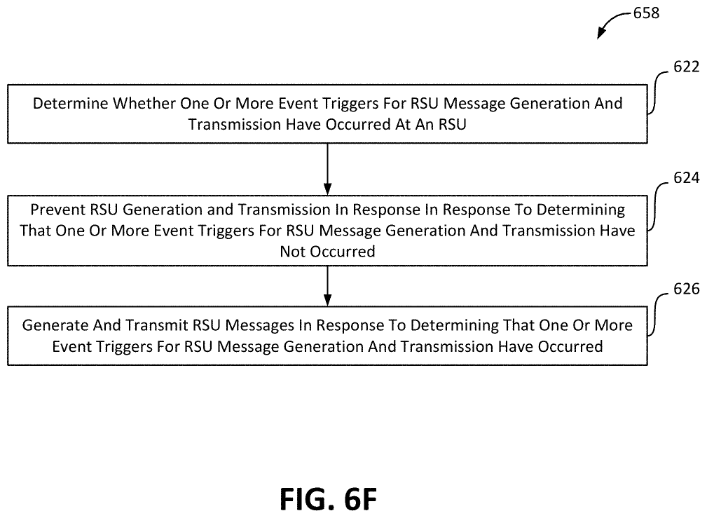

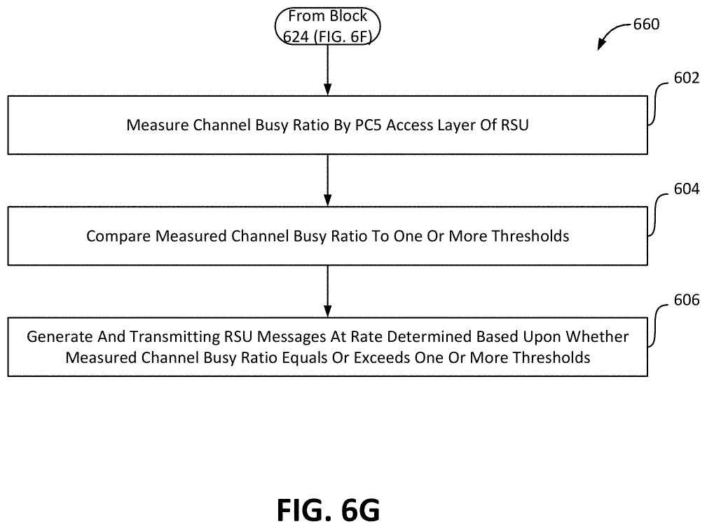

FIGS. 6A, 6B, 6C, 6D, 6E, 6F, and 6G are process flow diagrams illustrating methods for providing congestion control in RSU message scheduling according to various embodiments. The operations of the methods illustrated in FIGS. 6A, 6B, 6C, 6D, 6E, 6F, and 6G presented below are intended to be illustrative. In some embodiments, methods may be accomplished with one or more additional operations not described, and/or without one or more of the operations discussed. Additionally, the order in which the operations of methods as illustrated in 6A, 6B, 6C, 6D, 6E, 6F, and 6G and described below is not intended to be limiting.

In some embodiments, methods as illustrated in 6A, 6B, 6C, 6D, 6E, 6F, and 6G may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods as illustrated in 6A, 6B, 6C, 6D, 6E, 6F, and 6G in response to instructions stored electronically on an electronic storage medium. The one or more processing devices may include one or more devices configured through hardware, firmware, and/or software to be specifically designed for execution of one or more of the operations of the methods as illustrated in 6A, 6B, 6C, 6D, 6E, 6F, and 6G. For example, with reference to FIGS. 1-6G, the operations of the methods illustrated in 6A, 6B, 6C, 6D, 6E, 6F, and 6G may be performed by a processor (e.g., 201, 300, 302, 304, 371, 316, 318, 380, etc.) of Road Side Units (e.g., 108, 109, 200, 502).

FIG. 6A illustrates method 600, in accordance with one or more implementations.

In block 602, a processor of a Road Side Unit may measure a channel busy ratio by a PC5 access layer of a Road Side Unit. In various embodiments, each Road Side Unit may measure a channel busy ratio by a PC5 access layer of the Road Side Unit; compare the measured channel busy ratio to one or more thresholds; and generate and transmitting RSU messages at a rate determined based upon whether the measured channel busy ratio equals or exceeds the one or more thresholds. The channel busy ratio may be determined as a portion of sub-channels in the resource pool whose S-RSSI measured by the ITS station exceed a (pre-)configured threshold sensed over last 100 milliseconds (ms), a definition that is access layer dependent and specified in ETSI TS 136 214. The measured channel busy ratio (e.g., CBRmeasured) may be the channel busy ratio as measured by the PC5 access layer of the Road Side Unit.

In block 604, the processor of a Road Side Unit may compare the measured channel busy ratio to one or more thresholds. In various embodiments, the measured channel busy ratio may be compared to one or more thresholds, such as one, two, three, four, or more threshold. As one example, the one or more thresholds may be one or more ranges of channel busy ratios. In various embodiments, the one or more thresholds may be indicated in a look up table. The look up table may correlate the one or more thresholds with transmission rates to use for generation and transmission of RSU messages. As one example, the look up table may be a look up table of rates correlated to types of RSU messages and the one or more thresholds.

In block 606, the processor of a Road Side Unit may generate and transmit RSU messages at a rate determined based upon whether the measured channel busy ratio equals or exceeds the one or more thresholds. In various embodiments, the Road Side Unit may generate and transmit RSU messages at the rate determined based upon the measured channel busy ratio equaling or exceeding the one or more thresholds. For example, the RSU messages may be generated and transmitted at a rate listed in a look up table corresponding to the rate that was correlated with the threshold range in which the measured channel busy ratio was determined to fall. The reduction of the rate of RSU message generation and transmission as the measured channel busy ration increases may reduce the contribution of the Road Side Unit to potential congestion on the PC5 interface as potential congestion becomes more likely. The reduction of the rate of RSU message generation and transmission as the measured channel busy ration increases may enable the Road Side Unit to save energy by generating and transmitting fewer RSU messages when potential congestion on the PC5 interface is more likely.

FIG. 6B illustrates method 650, in accordance with one or more implementations. The operations of method 650 may be performed in conjunction with the operations of the method 600. The operations of method 650 may be operations performed to generate and transmit RSU messages at a rate determined based upon whether a measured channel busy ratio equals or exceeds one or more thresholds.

In block 608, the processor of a Road Side Unit may generate and transmit RSU messages at a first rate in response to the measured channel busy ratio being less than a first threshold.

In block 610, the processor of a Road Side Unit may generate and transmit RSU messages at a second rate that is less frequent than the first rate in response to the measured channel busy ratio equaling or exceeding the threshold.

FIG. 6C illustrates method 652, in accordance with one or more implementations. The operations of method 652 may be performed in conjunction with the operations of method 600. The operations of method 652 may be operations performed to generate and transmit RSU messages at a rate determined based upon whether a measured channel busy ratio equals or exceeds one or more thresholds

In block 612, the processor of a Road Side Unit may generate and transmit different types of RSU messages at type-specific first rates in response to the measured channel busy ratio being less than a first threshold. In various embodiments, the message generation and transmission rates may be different for different types of RSU messages correlated with the same threshold. Types of RSU messages may include SPAT messages; MAP messages, RSI messages, and RSMs.

In block 614, the processor of a Road Side Unit may generate and transmit different types of RSU messages at type-specific second rates that are less frequent than the type-specific first rates in response to the measured channel busy ratio equaling or exceeding the threshold.

FIG. 6D illustrates method 654, in accordance with one or more implementations. The operations of method 654 may be performed in conjunction with the operations of method 600. The operations of method 654 may be operations performed to generate and transmit RSU messages at a rate determined based upon whether a measured channel busy ratio equals or exceeds one or more thresholds

In block 616, the processor of a Road Side Unit may determine the rate for generating and transmitting RSU messages based upon whether the measured channel busy ratio equals or exceeds the one or more thresholds using a look up table of rates correlated to types of RSU messages and the one or more thresholds. In various embodiments, the measured channel busy ratio may be compared to one or more thresholds, such as one, two, three, four, or more threshold. In various embodiments, the one or more thresholds may be indicated in a look up table that correlates the one or more thresholds with transmission rates to use for generation and transmission of RSU messages.

FIG. 6E illustrates method 656, in accordance with one or more implementations. The operations of method 656 may be performed in conjunction with the operations of method 600. The operations of method 656 may be operations performed to generate and transmit RSU messages at a rate determined based upon whether a measured channel busy ratio equals or exceeds one or more thresholds.

In block 618, the processor of a Road Side Unit may determine whether one or more event triggers for RSU message generation and transmission have occurred. Various embodiments may include RSU message congestion control based on one or more event triggers. In various embodiments, a Road Side Unit may monitor states of the Road Side Unit and/or the vicinity around the Road Side Unit. The Road Side Unit may monitory states of the Road Side Unit and/or the vicinity around the Road Side Unit using sensors (e.g., radars, LIDAR, cameras, etc.) of the Road Side Unit and/or the detection of messages from other entities (e.g., BSMs from vehicles approaching the Road Side Unit). For example, a Road Side Unit may detect of a presence of an object (e.g., a vehicle, obstruction, etc.) or a participant (e.g., a pedestrian, a bicycle, an animal, etc.) in a vicinity of the Road Side Unit. The detection of the presence of an object or a participant in a vicinity of the Road Side Unit by the Road Side Unit may be an event trigger. As another example, the Road Side Unit may detection of a vehicle approaching the Road Side Unit. The detection of the vehicle approaching the Road Side Unit may be an event trigger. In various embodiments, event triggers may be based at least in part on the RSU message type. For example, event triggers for RSI messages may be different than event triggers for RSMs. As specific examples, the detection of a presence of an object or a participant in a vicinity of the Road Side Unit may be an event trigger for an RSM and the detection of a vehicle approaching the Road Side Unit may be an event trigger for an RSI message.

In block 620, the processor of a Road Side Unit may generate and transmit RSU messages at a rate determined based upon whether the measured channel busy ratio equals or exceeds the one or more thresholds in response to determining that one or more event triggers for RSU message generation and transmission has occurred. In various embodiments, the Road Side Unit may not generate RSU messages until one or more event triggers is determined to have occurred. In various embodiments, the Road Side Unit may determine whether one or more event triggers for RSU messages have occurred at the Road Side Unit. In response to determining that one or more event triggers for RSU messages have not occurred, the Road Side Unit may not transmit RSU messages. In response to determining that one or more event triggers for RSU messages have occurred, the Road Side Unit may generate and transmit RSU messages. In various embodiments, the generation and transmission of RSU messages in response to determining that one or more event triggers for RSU message generation and transmission has occurred may be based at least in part on the measured channel busy ratio.

FIG. 6F illustrates method 658, in accordance with one or more implementations.

In block 622, the processor of a Road Side Unit may determine whether one or more event triggers for RSU message generation and transmission have occurred at a Road Side Unit. In various embodiments, a Road Side Unit may monitor states of the Road Side Unit and/or the vicinity around the Road Side Unit. The Road Side Unit may monitory states of the Road Side Unit and/or the vicinity around the Road Side Unit using sensors (e.g., radars, LIDAR, cameras, etc.) of the Road Side Unit and/or the detection of messages from other entities (e.g., BSMs from vehicles approaching the Road Side Unit). For example, a Road Side Unit may detect of a presence of an object (e.g., a vehicle, obstruction, etc.) or a participant (e.g., a pedestrian, a bicycle, an animal, etc.) in a vicinity of the Road Side Unit. The detection of the presence of an object or a participant in a vicinity of the Road Side Unit by the Road Side Unit may be an event trigger. As another example, the Road Side Unit may detection of a vehicle approaching the Road Side Unit. The detection of the vehicle approaching the Road Side Unit may be an event trigger. In various embodiments, event triggers may be based at least in part on the RSU message type. For example, event triggers for RSI messages may be different than event triggers for RSMs. As specific examples, the detection of a presence of an object or a participant in a vicinity of the Road Side Unit may be an event trigger for an RSM and the detection of a vehicle approaching the Road Side Unit may be an event trigger for an RSI message.

In block 624, the processor of a Road Side Unit may prevent or suspend RSU message generation and transmission in response to determining that one or more event triggers for RSU messages have not occurred. In various embodiments, the Road Side Unit may not transmit RSU messages until one or more event triggers is determined to have occurred. In various embodiments, the Road Side Unit may determine whether one or more event triggers for RSU message generation and transmission have occurred at the Road Side Unit.

In block 626, the processor of a Road Side Unit may generate and transmit RSU messages in response to determining that one or more event triggers for RSU messages has occurred. In various embodiments, the rate at which RSU messages are generated and transmitted in response to determining that one or more event triggers for RSU message generation and transmission has occurred may be based at least in part on the measured channel busy ratio.

FIG. 6G illustrates method 660, in accordance with one or more implementations. The operations of method 660 may be performed in conjunction with the operations of method 658. The operations of method 660 may be performed in response to determining that one or more event triggers for RSU message generation and transmission has occurred.

In block 602, the processor of a Road Side Unit may measure a channel busy ratio by a PC5 access layer of the Road Side Unit as described for the like number block in the method 600 (FIG. 6A).

In block 604, the processor of a Road Side Unit may compare the measured channel busy ratio to one or more thresholds as described for the like number block in the method 600 (FIG. 6A).

In block 606, the processor of a Road Side Unit may generate and transmit RSU messages at a rate determined based upon whether the measured channel busy ratio equals or exceeds the one or more thresholds as described for the like number block in the method 600 (FIG. 6A).

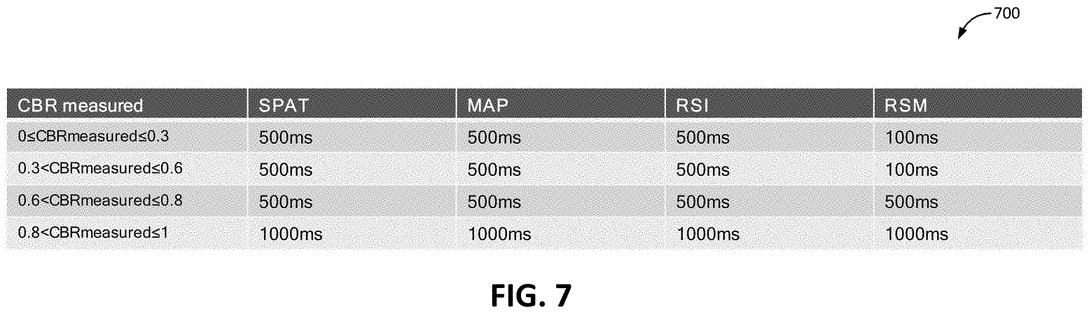

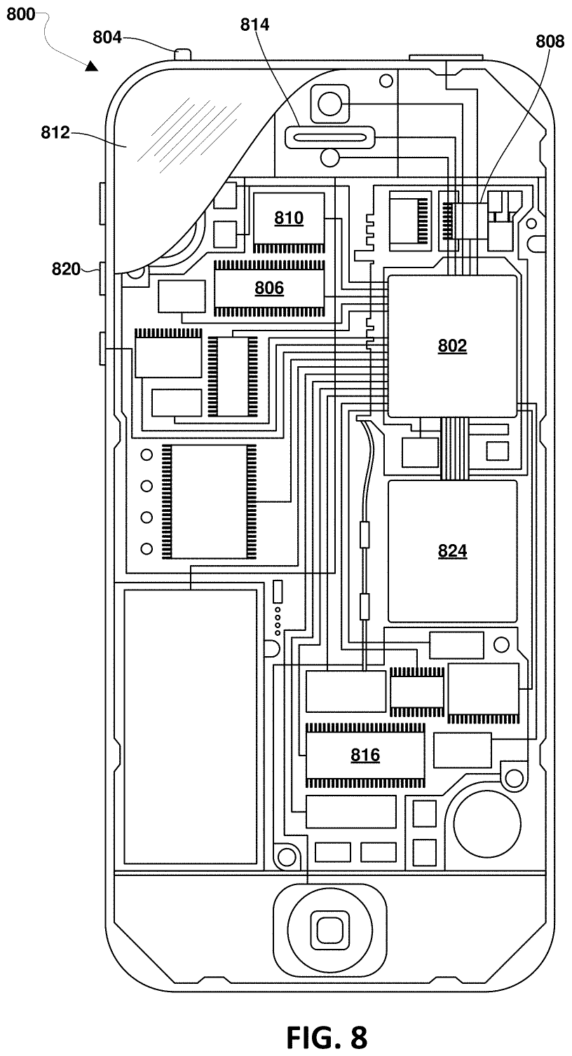

FIG. 7 illustrates an example look up table 700 of rates correlated to type of RSU messages and one or more thresholds according to various embodiments. With reference to FIGS. 1-7, the look up table 700 includes rows for four threshold ranges of measured channel busy ratios correlated with different transmission rates for different types of RSU messages, specifically SPAT messages, MAP messages, RSI messages, and RSMs. For example, in accordance with one or more of the operations of the methods illustrated in 6A, 6B, 6C, 6D, 6E, 6F, and/or 6G, a Road Side Unit may match a measured channel busy ratio to its respective measured channel busy ratio threshold range and, based on a type of RSU message to be transmitted, determine from the look up table 700 the corresponding listed transmission rate to use for that matching threshold range.

The processors implementing various embodiments may be any programmable microprocessor, microcomputer or multiple processor chip or chips that can be configured by software instructions (applications) to perform a variety of functions, including the functions of the various aspects described in this application. In some communication devices, multiple processors may be provided, such as one processor dedicated to wireless communication functions and one processor dedicated to running other applications. Typically, software applications may be stored in the internal memory before they are accessed and loaded into the processor. The processor may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a processor of a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or Data structures stored thereon. Components may communicate by way of local and/or remote processes, function or procedure calls, electronic signals, Data packets, memory read/writes, and other known network, computer, processor, and/or process related communication methodologies.

A number of different cellular and mobile communication services and standards are available or contemplated in the future, all of which may implement and benefit from the various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), integrated digital enhanced network (iden), C-V2X, V2V, V2P, V2I, and V2N, etc. Each of these technologies involves, for example, the transmission and reception of voice, Data, signaling, and/or content Messages. It should be understood that any references to terminology and/or technical details related to an individual telecommunication standard or technology are for illustrative purposes only, and are not intended to limit the scope of the Claims to a particular communication system or technology unless specifically recited in the claim language.

Various aspects illustrated and described are provided merely as examples to illustrate various features of the Claims. However, features shown and described with respect to any given aspect are not necessarily limited to the associated aspect and may be used or combined with other aspects that are shown and described. Further, the Claims are not intended to be limited by any one example aspect. For example, one or more of the operations of the methods may be substituted for or combined with one or more operations of the methods.

The foregoing method descriptions and the process flow diagrams are provided merely as illustrative examples and are not intended to require or imply that the operations of various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such aspect decisions should not be interpreted as causing a departure from the scope of the Claims.

The hardware used to implement various illustrative logics, logical blocks, modules, and circuits described in connection with the aspects disclosed herein may be implemented or performed with a general purpose processor, a digital Signal processor (DSP), an ASIC, a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or Data structures and that may be accessed by a computer. Disk and disc, as used herein, includes compact disc (CD), laser disc, optical disc, digital versatile disc (DVD), floppy disk, and Blu-ray disc where disks usually reproduce Data magnetically, while discs reproduce Data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make or use the Claims. Various modifications to these aspects will be readily apparent to those skilled in the art, and the generic principles defined herein may be applied to other aspects without departing from the scope of the Claims. Thus, the present disclosure is not intended to be limited to the aspects shown herein but is to be accorded the widest scope consistent with the following Claims and the principles and novel features disclosed herein.

What is claimed is:

1. A method of providing congestion control in Road Side Unit message (“RSU message”) scheduling, comprising:
measuring a channel busy ratio by a PC5 access layer of a Road Side Unit;
comparing the measured channel busy ratio to one or more thresholds; and
generating and transmitting RSU messages at a rate determined based upon whether the measured channel busy ratio equals or exceeds the one or more thresholds.

2. The method of claim 1, wherein generating and transmitting RSU messages at a rate determined based upon whether the measured channel busy ratio equals or exceeds the one or more thresholds comprises:
generating and transmitting RSU messages at a first rate in response to the measured channel busy ratio being less than a first threshold; and
generating and transmitting RSU messages at a second rate that is less frequent than the first rate in response to the measured channel busy ratio equaling or exceeding the first threshold.

3. The method of claim 1, wherein generating and transmitting RSU messages at a rate determined based upon whether the measured channel busy ratio equals or exceeds the one or more thresholds comprises:
generating and transmitting different types of RSU messages at type-specific first rates in response to the measured channel busy ratio being less than a first threshold; and
generating and transmitting different types of RSU messages at type-specific second rates that are less frequent than the type-specific first rates in response to the measured channel busy ratio equaling or exceeding the first threshold.

4. The method of claim 3, wherein the different types of RSU messages include Signal Phase and Timing (SPAT) messages; Map Data (MAP) messages, Road Sign Information (RSI) messages, and Road Safety Messages (RSM).

5. The method of claim 3, further comprising determining the rate for generating and transmitting RSU messages based upon whether the measured channel busy ratio equals or exceeds the one or more thresholds using a look up table of rates correlated to types of RSU messages and the one or more thresholds.

6. The method of claim 1, further comprising:
determining whether one or more event triggers for RSU message generation and transmission have occurred,
wherein generating and transmitting RSU messages at the rate determined based upon whether the measured channel busy ratio equals or exceeds the one or more thresholds comprises generating and transmitting RSU messages at the rate determined based upon whether the measured channel busy ratio equals or exceeds the one or more thresholds in response to determining that one or more event triggers for RSU message generation and transmission have occurred.

7. A method of providing congestion control in Road Side Unit message (“RSU message”) scheduling, comprising:
determining whether one or more event triggers for RSU message generation and transmission have occurred at a Road Side Unit;
preventing RSU message generation and transmission in response to determining that that one or more event triggers for RSU message generation and transmission have not occurred; and
generating and transmitting RSU messages in response to determining that one or more event triggers for RSU message generation and transmission have occurred.

8. The method of claim 7, wherein generating and transmitting RSU messages in response to determining that one or more event triggers for RSU message generation and transmission have occurred comprises:
measuring a channel busy ratio by a PC5 access layer of the Road Side Unit;
comparing the measured channel busy ratio to one or more thresholds; and
generating and transmitting RSU messages at a rate determined based upon whether the measured channel busy ratio equals or exceeds the one or more thresholds.

9. The method of claim 7, wherein the one or more event triggers are based at least in part on an RSU message type.

10. The method of claim 9, wherein the RSU message type is an RSM and an event trigger is a detection of a presence of an object or a participant in a vicinity of the Road Side Unit.

11. The method of claim 9, wherein the RSU message type is an RSI and an event trigger is a detection of a vehicle approaching the Road Side Unit.

12. A Road Side Unit, comprising:
a transceiver; and
a processor coupled to the transceiver and configured with processor-executable instructions to:
measure a channel busy ratio by a PC5 access layer;
compare the measured channel busy ratio to one or more thresholds; and
generate and transmit Road Side Unit messages (“RSU messages”) at a rate determined based upon whether the measured channel busy ratio equals or exceeds the one or more thresholds.

13. The Road Side Unit of claim 12, wherein the processor is further processor-executable instructions to generate and transmit RSU messages at a rate determined based upon whether the measured channel busy ratio equals or exceeds the one or more thresholds by:
generating and transmitting RSU messages at a first rate in response to the measured channel busy ratio being less than a first threshold; and
generating and transmitting RSU messages at a second rate that is less frequent than the first rate in response to the measured channel busy ratio equaling or exceeding the first threshold.

14. The Road Side Unit of claim 12, wherein the processor is further processor-executable instructions to generate and transmit RSU messages at a rate determined based upon whether the measured channel busy ratio equals or exceeds the one or more thresholds by:
generating and transmitting different types of RSU messages at type-specific first rates in response to the measured channel busy ratio being less than a first threshold; and
generating and transmitting different types of RSU messages at type-specific second rates that are less frequent than the type-specific first rates in response to the measured channel busy ratio equaling or exceeding the first threshold.

15. The Road Side Unit of claim 14, wherein the different types of RSU messages include Signal Phase and Timing (SPAT) messages; Map Data (MAP) messages, Road Sign Information (RSI) messages, and Road Safety Messages (RSM).

16. The Road Side Unit of claim 14, wherein the processor is further processor-executable instructions to determine the rate for generating and transmitting RSU messages based upon whether the measured channel busy ratio equals or exceeds the one or more thresholds using a look up table of rates correlated to types of RSU messages and the one or more thresholds.

17. The Road Side Unit of any of claim 12, wherein the processor is further processor-executable instructions to:
determine whether one or more event triggers for RSU message generation and transmission have occurred,
wherein the processor is further processor-executable instructions to generate and transmit RSU messages at the rate determined based upon whether the measured channel busy ratio equals or exceeds the one or more thresholds by generating and transmitting RSU messages at the rate determined based upon whether the measured channel busy ratio equals or exceeds the one or more thresholds in response to determining that one or more event triggers for RSU message generation and transmission have occurred.

18. A Road Side Unit, comprising:
a transceiver; and
a processor coupled to the transceiver and configured with processor-executable instructions to:
determining whether one or more event triggers for Road Side Unit message (“RSU message”) generation and transmission have occurred;
preventing RSU message generation and transmission in response to determining that that one or more event triggers for RSU message generation and transmission have not occurred; and
generating and transmitting RSU messages in response to determining that one or more event triggers for RSU message generation and transmission have occurred.

19. The Road Side Unit of claim 18, wherein the processor is further processor-executable instructions to generate and transmit RSU messages in response to determining that one or more event triggers for RSU message generation and transmission have occurred by:
measuring a channel busy ratio by a PC5 access layer of the Road Side Unit;
comparing the measured channel busy ratio to one or more thresholds; and
generating and transmitting RSU messages at a rate determined based upon whether the measured channel busy ratio equals or exceeds the one or more thresholds.

20. The Road Side Unit of claim 18, wherein the one or more event triggers are based at least in part on an RSU message type.

21. The Side Unit of claim 20, wherein the RSU message type is an RSM and an event trigger is a detection of a presence of an object or a participant in a vicinity of the Road Side Unit.

22. The Side Unit of claim 20, wherein the RSU message type is an RSI and an event trigger is a detection of a vehicle approaching the Road Side Unit.

23. A non-transitory processor-readable medium having stored thereon processor-executable instructions configured to cause a processor of a Road Side Unit to perform operations comprising:
measuring a channel busy ratio by a PC5 access layer of the Road Side Unit;
comparing the measured channel busy ratio to one or more thresholds; and
generating and transmitting Road Side Unit messages (“RSU messages”) at a rate determined based upon whether the measured channel busy ratio equals or exceeds the one or more thresholds.

24. The non-transitory processor-readable medium of claim 23, wherein the stored processor-executable instructions are configured to cause a processor of a Road Side Unit to perform operations such that generating and transmitting RSU messages at a rate determined based upon whether the measured channel busy ratio equals or exceeds the one or more thresholds comprises:
generating and transmitting RSU messages at a first rate in response to the measured channel busy ratio being less than a first threshold; and
generating and transmitting RSU messages at a second rate that is less frequent than the first rate in response to the measured channel busy ratio equaling or exceeding the first threshold.

25. The non-transitory processor-readable medium of claim 23, wherein generating and transmitting RSU messages at a rate determined based upon whether the measured channel busy ratio equals or exceeds the one or more thresholds comprises:
generating and transmitting different types of RSU messages at type-specific first rates in response to the measured channel busy ratio being less than a first threshold; and
generating and transmitting different types of RSU messages at type-specific second rates that are less frequent than the type-specific first rates in response to the measured channel busy ratio equaling or exceeding the first threshold.

26. The non-transitory processor-readable medium of claim 25, wherein the different types of RSU messages include Signal Phase and Timing (SPAT) messages;
Map Data (MAP) messages, Road Sign Information (RSI) messages, and Road Safety Messages (RSM).

27. The non-transitory processor-readable medium of claim 25, further comprising determining the rate for generating and transmitting RSU messages based upon whether the measured channel busy ratio equals or exceeds the one or more thresholds using a look up table of rates correlated to types of RSU messages and the one or more thresholds.

28. The non-transitory processor-readable medium of claim 23, further comprising:
determining whether one or more event triggers for RSU message generation and transmission have occurred,
wherein generating and transmitting RSU messages at the rate determined based upon whether the measured channel busy ratio equals or exceeds the one or more thresholds comprises generating and transmitting RSU messages at the rate determined based upon whether the measured channel busy ratio equals or exceeds the one or more thresholds in response to determining that one or more event triggers for RSU message generation and transmission have occurred.

29. A non-transitory processor-readable medium having stored thereon processor-executable instructions configured to cause a processor of a Road Side Unit to perform operations comprising:
determining whether one or more event triggers for Road Side Unit message (“RSU message”) generation and transmission have occurred at the Road Side Unit;
preventing RSU message generation and transmission in response to determining that that one or more event triggers for RSU message generation and transmission have not occurred; and
generating and transmitting RSU messages in response to determining that one or more event triggers for RSU message generation and transmission have occurred.

30. The non-transitory processor-readable medium of claim 29, wherein generating and transmitting RSU messages in response to determining that one or more event triggers for RSU message generation and transmission have occurred comprises:
measuring a channel busy ratio by a PC5 access layer of the Road Side Unit;
comparing the measured channel busy ratio to one or more thresholds; and
generating and transmitting RSU messages at a rate determined based upon whether the measured channel busy ratio equals or exceeds the one or more thresholds.

31. The non-transitory processor-readable medium of claim 29, wherein the one or more event triggers are based at least in part on an RSU message type.

32. The non-transitory processor-readable medium of claim 31, wherein the RSU message type is an RSM and an event trigger is a detection of a presence of an object or a participant in a vicinity of the Road Side Unit.

33. The non-transitory processor-readable medium of claim 31, wherein the RSU message type is an RSI and an event trigger is a detection of a vehicle approaching the Road Side Unit.

34. A Road Side Unit, comprising:
means for measuring a channel busy ratio by a PC5 access layer of the Road Side Unit;
means for comparing the measured channel busy ratio to one or more thresholds; and
means for generating and transmitting Road Side Unit messages (“RSU messages”) at a rate determined based upon whether the measured channel busy ratio equals or exceeds the one or more thresholds.

35. A Road Side Unit, comprising:
means for determining whether one or more event triggers for Road Side Unit message (“RSU message”) generation and transmission have occurred at the Road Side Unit;
means for preventing RSU message generation and transmission in response to determining that that one or more event triggers for RSU message generation and transmission have not occurred;
means for measuring a channel busy ratio by a PC5 access layer of the Road Side Unit;
means for comparing the measured channel busy ratio to one or more thresholds; and
means for generating and transmitting RSU messages at a rate determined based upon whether the measured channel busy ratio equals or exceeds the one or more thresholds in response to determining that one or more event triggers for RSU message generation and transmission have occurred.
